(19) United States
(12) Patent Application Publication
(10) Pub. No.: US 2025/0272627 A1
(43) Pub. Date: Aug. 28, 2025

(54) Machine Learning Model for Identifying Expertise within an Organization

(71) Applicant: DigiCert, Inc., Lehi, UT (US)

(72) Inventor: Avesta Hojjati, Austin, TX (US)

(73) Assignee: DigiCert, Inc., Lehi, UT (US)

(21) Appl. No.: 18/590,602

(22) Filed: Feb. 28, 2024

(51) Int. Cl. G06Q 10/0631; G06N 3/0895

(52) U.S. Cl. CPC G06Q 10/063112; G06N 3/0895

(57) ABSTRACT

Systems and methods for providing directory support in an organization are described. A method, according to one implementation, includes gathering digital data from multiple sources within an organization. The method also includes indexing the digital data in a table that includes at least a first column including names of a plurality of members of the organization and a second column including keywords attributed to the plurality of members. Also, the method includes training a Machine Learning (ML) model by data crawling through the digital data, assigning weights to the keywords, and storing the weights in a third column in the table. In response to receiving an inquiry from a user, the ML model is configured during inference to use information in the table to provide an output to the user identifying a member in the organization who demonstrates expertise on a specific topic.

### FIELD OF THE DISCLOSURE

The present disclosure relates generally to machine learning. More particularly, the present disclosure relates to systems and methods for using a machine learning model to identify and locate a member of an organization who is determined to be an expert or have experience with respect to a particular topic.

### BACKGROUND

Within an organization, particularly a larger organization, it can be difficult and time-consuming for someone to find the right person to talk with when they wish to get the answers to certain questions that might be outside of their normal realm of knowledge. For example, a person in one department may not know what an expert in another department would know. Searching for the ideal person to talk with can also be frustrating. Also, when hunting down the right person, the inquirer may encounter multiple people who may then be interrupted from their normal duties to explain that they do not know about the subject and might even misdirect the person to others who cannot answer the questions. In the end, this scenario results in a great deal of wasted time throughout the organization.

### BRIEF SUMMARY

The present disclosure relates to systems and methods for providing directory support or assistance to help users identify and locate one or more people who are deemed to be experts or knowledgeable in various fields or with respect to a certain topic. That is, the present disclosure includes creation and use of a machine learning model which can assist in locating expert knowledge within an organization. According to one implementation, a method includes the step of gathering digital data from multiple sources within an organization. The method also includes a step of indexing the digital data in a table that includes at least a first column including names of a plurality of members of the organization and a second column including keywords attributed to the plurality of members. Also, the method includes a step of training a Machine Learning (ML) model by data crawling through the digital data, assigning weights to the keywords, and storing the weights in a third column in the table. In response to receiving an inquiry from a user, the ML model is configured during inference to use information in the table to provide an output to the user identifying a member in the organization who demonstrates expertise on a specific topic.

According to additional embodiments, the step of training the ML model may include a deep learning neural network process. The deep learning neural network process, for example, may involve a Large Language Model (LLM). The ML model, in some embodiments, may include a chatbot for receiving the inquiry and providing the output. The chatbot, for instance, may use Natural Language Processing (NLP). The inquiry may include the specific topic or one or more of the keywords.

The step of gathering the digital data may include obtaining data from a plurality of databases. The databases, for example, may include at least a plurality of data silos each configured to store data in conjunction with use of one or more of collaboration tools, wiki tools, file sharing tools, messaging or chat tools, project management tools, and issue tracking tools associated with multiple different internal groups within the organization. In some embodiments, the user associated with the inquiry may be a fellow member of the organization (internal inquiry).

In some embodiments, the method may be associated with systems, non-transitory computer-readable media, etc., which may include a back-end training component. The back-end training component may be configured to perform a rudimentary crawling or scraping process to store the digital data in the table and may further be configured to train the ML model. Also, a front-end inference component may be configured to a) receive the inquiry from a user device associated with the user, b) utilize the ML model and a data warehouse associated with the table to identify one or more members in the organization who demonstrate expertise on the specific topic, and c) provide the output to the user with an explanation describing how expertise is evaluated. The back-end training component may be configured to receive feedback for retraining the ML model.

Also, according to some implementations, the method may further include the steps of counting a number of times each keyword is attributed to the plurality of members and storing an occurrence count in a fourth column in the table. The ML model, for example, may be configured to utilize the names, keywords, weights, occurrence counts, and/or proximity to time of use of the keywords to identify the member who demonstrates expertise in the specific topic.

In various embodiments, the present disclosure includes a) methods having the above-mentioned steps, b) processing devices configured to implement the above-mentioned steps, c) cloud services configured to implement the above-mentioned steps, and d) non-transitory computer-readable media storing instructions for programming one or more processors to execute the above-mentioned steps.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a block diagram illustrating an organization having a plurality of isolated data storage devices, according to various embodiments.

FIG. 2 is a block diagram illustrating the directory support device shown in FIG. 1, according to various embodiments.

FIG. 3 is a block diagram illustrating a locating system involving the expert identifying module shown in FIG. 2, according to various embodiments.

FIG. 4 is a diagram illustrating a user interface box for gathering information about people within an organization, according to various embodiments.

FIG. 5 is a table for storing names of people associated with an organization, keywords used by or attributed to the people, number of occurrences of the keywords, and weights of the keywords, according to various embodiments.

FIG. 6 is a block diagram illustrating a Large Language Model (LLM) based architecture, according to various embodiments.

FIG. 7 is a block diagram illustrating a language-based architecture, according to various embodiments.

FIG. 8 is a flow diagram illustrating a method for training a Machine Learning (ML) model for enabling a user to identify one or more people of an organization having expertise or knowledge in a specific topic or area of concern, according to various embodiments.

### DETAILED DESCRIPTION

Again, the present disclosure relates to systems and methods for providing directory assistance or support for someone in an organization who is looking for answers outside of their own area of expertise. This is particularly problematic in a large organization that includes hundreds or thousands of people. The process of hunting down the right person for answers can be time-consuming and frustrating for everyone involved. Therefore, there is a need for an internal tool that can be used by the people within an organization to identify and locate the right person to talk to about a certain subject.

### Isolated Databases in an Organization

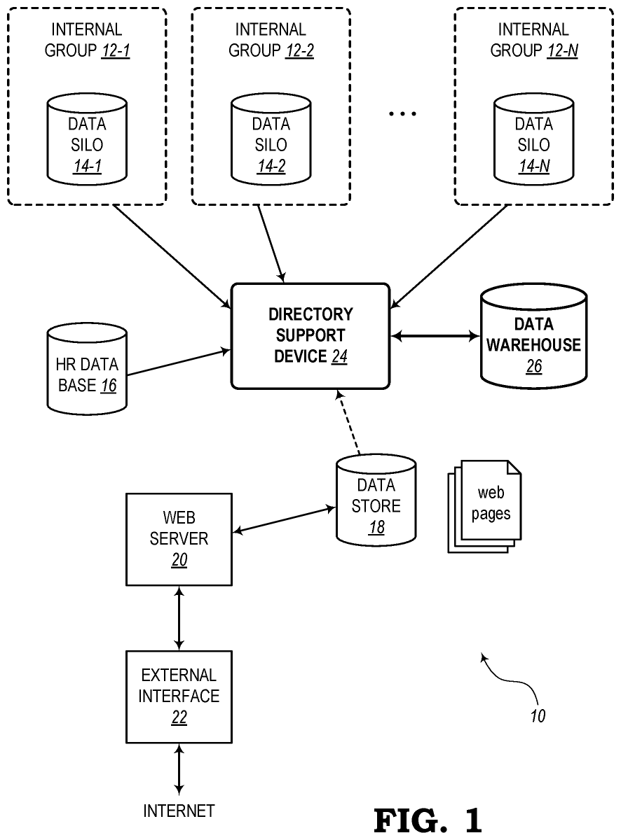

FIG. 1 is a block diagram illustrating an embodiment of an organization 10 having a plurality of isolated data storage devices. For example, the organization 10 may be a company, business, corporation, enterprise, university, or other entity where a group of people may be associated with each other and may communicate internally with each other using various user devices (e.g., computers, laptops, tablets, smart phones, etc.) (not shown).

As illustrated in FIG. 1, the organization 10 includes a number of internal groups 12-1, 12-2, . . . , 12-N, which may each be associated with specifically identifiable collections of people and equipment having their own sets of goals, responsibilities, areas of knowledge and expertise, etc. The internal groups 12 may represent different departments, branches, subdivisions, sectors, etc. within the organization 10. Each group 12 may have its own specific set of software tools or other equipment for enabling the members of that group 12 to collaborate on projects, share ideas, work together to accomplish specific goals, etc. For example, one internal group 12 may be associated with Human Resources (HR) of the organization 10. Another may be associated with Information Technology (IT) within the organization 10, while another may be associated with Research and Development (R&D) or engineering within the organization 10, and so on.

Within each internal group 12, the organization 10 may further include one or more data silos 14-1, 14-2, . . . , 14-N. Each data silo 14 of a particular internal group 12 may be isolated from the members of other internal groups 12. For instance, information regarding Mergers and Acquisitions (M&A) may be stored in a data silo 14 associated with an internal group 12 related to people responsible for M&A processes and other such responsibilities, but it may be noted in many cases that the M&A data silo may contain information that is isolated from (and not particularly useful to) members of the IT group on a regular basis, although some organizations may be structured where one or more people may be part of both teams. As shown, the organization 10 may also include an HR database 16, which may be another data silo 14 used for storing personal information about employees. Again, the HR database 16 may be isolated from the data silos 14-1, 14-2, . . . , 14-N to protect the personal information of employees from others who do not need this information.

Furthermore, the organization 10 (as is common) may have an online presence and have one or more websites and webpages allowing users outside of the organization 10 to access certain data stored in a data store 18. For example, the data store 18 may be configured to store information, computer code, etc. of the one or more websites and webpages. The data store 18 may be configured to store information pertaining to employee experience, credentials, etc., which may be intended as a marketing strategy for demonstrating the skills of the employees to draw additional business and to allow customers or potential customers to contact certain people within the organization 10 who can provide help when needed. A web server 20 may be configured to retrieve information from the data store 18 and communicate with external devices on the Internet via an external interface 22.

Thus, the organization 10 may include any number of various databases (e.g., data silos 14, HR database 16, data store 18, etc.), where there may be little or no overlap between the different sources of data. Since the data within the organization 10 may be stored in such an isolated manner, one person in the organization 10 normally would not be able to access all the available data associated with the organization 10, unless that person had special privileges or their job required such access.

However, there are often times when a person in the organization 10 may wish to contact someone else within the organization 10 to ask about some topic that is normally outside the person's normal realm of knowledge. For example, an IT member may have questions about the company's pension plans or health insurance coverage and may wish to contact someone in HR. A problem, however, is that it can be difficult and time-consuming for members of the organization 10 to easily find help or answers outside their normal sphere of contacts. Not only will a person spend unnecessary amounts of time trying to contact the right person or trying to find where to go to find the answer, but one or more people (usually multiple people) will be interrupted from their normal duties to answer questions about who that right person might be, to explain why they do not know who that right person is, provide random guesses as to who might be able to direct the inquirer to the right person, etc. Therefore, in order to provide better support and reduce frustration, the systems and methods of the present disclosure introduce a directory support device 24 for the members of the organization 10, as described herein.

The directory support device 24 may include hardware and software components for assisting employees or other members of the organization 10 with respect to identifying and/or locating others within the organization 10 who can help with certain topics or areas of knowledge. The directory support device 24 is configured to retrieve data from the various databases 14, 16, 18 and may then store this data in a data warehouse 26 (or data lake). The data warehouse 26 may be a relational database and may include tables (with fixed rows and columns) or other suitable structure for handling information. The data stored in the data warehouse 26 may be indexed in a particular manner in order to easily retrieve information as needed according to the implementations described in the present disclosure. For example, the data may be stored in a table, such as is shown in the example of the table 70 shown in FIG. 5. This data ultimately can be manipulated and then used to train a machine learning model.

Although each person may not be able to directly access the data in the data warehouse 26, the directory support device 24 is configured to receive enquiries from members of the organization 10 and utilize the data warehouse 26 to find other people who are found to be experts or have sufficient knowledge about a certain topic. By using Artificial Intelligence (AI) or Machine Learning (ML), the directory support device 24 can sift through the vast amounts of data within the organization 10 and analyze the data to determine an expertise of different people on a number of different topics. Then, the directory support device 24 can provide an answer to the inquirer that directs him or her to the right person in a quick and accurate manner without the tedious hunting procedure that normally exists in a business.

### Directory Support Device

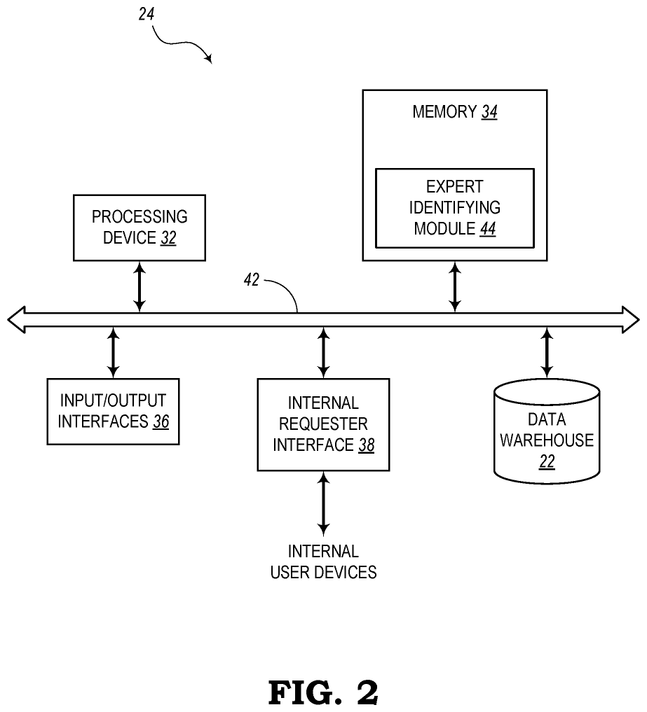

FIG. 2 is a block diagram illustrating an embodiment of the directory support device 24 shown in FIG. 1. The directory support device 24 may be a digital computer that, in terms of hardware architecture, generally includes a processing device 32, memory 34, input/output (I/O) interfaces 36, an internal requester interface 38, and the data warehouse 22. It should be appreciated by those of ordinary skill in the art that FIG. 2 depicts the directory support device 24 in a simplified manner, and a practical embodiment may include additional components and suitably configured processing logic to support known or conventional operating features that are not described in detail herein. The components (32, 34, 36, 38, 22) are communicatively coupled via a local interface 42. The local interface 42 may be, for example, but not limited to, one or more buses or other wired or wireless connections, as is known in the art. The local interface 42 may have additional elements, which are omitted for simplicity, such as controllers, buffers (caches), drivers, repeaters, and receivers, among many others, to enable communications. Further, the local interface 42 may include address, control, and/or data connections to enable appropriate communications among the aforementioned components.

The processing device 32 is a hardware device for executing software instructions. The processing device 32 may be any custom made or commercially available processor, a Central Processing Unit (CPU), an auxiliary processor among several processors associated with the directory support device 24, a semiconductor-based microprocessor (in the form of a microchip or chipset), or generally any device for executing software instructions. When the directory support device 24 is in operation, the processing device 32 is configured to execute software stored within the memory 34, to communicate data to and from the memory 34, and to generally control operations of the directory support device 24 pursuant to the software instructions. The I/O interfaces 36 may be used to receive user input from and/or for providing system output to one or more devices or components.

The internal requester interface 38 may be used to enable the directory support device 24 to communicate on a network, such as the Internet. The internal requester interface 38 may include, for example, an Ethernet card or adapter or a Wireless Local Area Network (WLAN) card or adapter. The internal requester interface 38 may include address, control, and/or data connections to enable appropriate communications on the network. A data warehouse 22 (e.g., one or more databases, data stores, etc.) may be used to store data. The data warehouse 22 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data warehouse 22 may incorporate electronic, magnetic, optical, and/or other types of storage media. In one example, the data warehouse 22 may be located internal to the directory support device 24, such as, for example, an internal hard drive connected to the local interface 42 in the directory support device 24. Additionally, in another embodiment, the data warehouse 22 may be located external to the directory support device 24 such as, for example, an external hard drive connected to the I/O interfaces 36 (e.g., SCSI or USB connection). In a further embodiment, the data warehouse 22 may be connected to the directory support device 24 through a network, such as, for example, a network-attached file server.

The memory 34 may include volatile memory elements (e.g., random access memory (RAM, such as DRAM, SRAM, SDRAM, etc.)), nonvolatile memory elements (e.g., ROM, hard drive, tape, CDROM, etc.), or combinations thereof. Moreover, the memory 34 may incorporate electronic, magnetic, optical, and/or other types of storage media. Note that the memory 34 may have a distributed architecture, where various components are situated remotely from one another but can be accessed by the processing device 32. The software in memory 34 may include one or more software programs, each of which includes an ordered listing of executable instructions for implementing logical functions. The software in the memory 34 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The directory support device 24 further includes an expert identifying module 44 that may be implemented in any suitable combination of hardware (e.g., configured in the processing device 32) and/or software/firmware (e.g., configured in the memory 34). The expert identifying module 44 may be stored in any suitable non-transitory computer-readable media (e.g., the memory 34) and may include computer logic or code having instructions that enable or cause the processing device 32 to perform certain actions as discussed in the present disclosure.

The expert identifying module 44 may be configured to enable the processing device 32 to receive an inquiry or request from one person for finding another person. The expert identifying module 44 then allows the processing device 32 to locate one or more people within the organization 10 (according to digital records stored in the various databases) who demonstrate experience and/or knowledge about specific topics. The expertise of an individual may be based on the association of various keywords with the individual, which may be used to evaluate how productive, prolific, and/or skilled that individual is deemed to be on a specific requested topic. The expert identifying module 44 may be AI-based or ML-based as a result of intelligence associations of weighted keywords with different individuals. In some embodiments, the enquiries (requests) may be received using Natural Language Processing (NLP) (e.g., using a chatbot) and answers (results) to the enquiries may also be provided using NLP, chatbots, etc.

Of note, the general architecture of the directory support device 24 can define any device described herein. However, the directory support device 24 is merely presented as an example architecture for illustration purposes. Other physical embodiments are contemplated, including virtual machines (VM), software containers, appliances, network devices, and the like.

In one embodiment, the various techniques described herein can be implemented via a cloud service associated with the web server 20. Although not shown in the architecture of FIG. 1, the directory support device 24 in this case may be connected to the web server 20 for serving external customers (e.g., after login). Thus, the directory support device 24 may be configured to receive external enquiries via the Internet to allow customers to find out who to contact for certain information or services. In this sense, the data warehouse 26 may be structured in a specific way in order to keep a firewall between internal data and external data. Thus, external users will only be able to get information that is considered to be public data, which may be available, to some degree, to customers outside the organization 10. External enquiries may be limited to allow external users to find only general information, non-sensitive information, etc. in such a cloud service architecture. Nevertheless, the cloud customers may still be able to find an employee more quickly and with less hassle than conventional processes.

Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

### Locating System and Expert Identifying Module

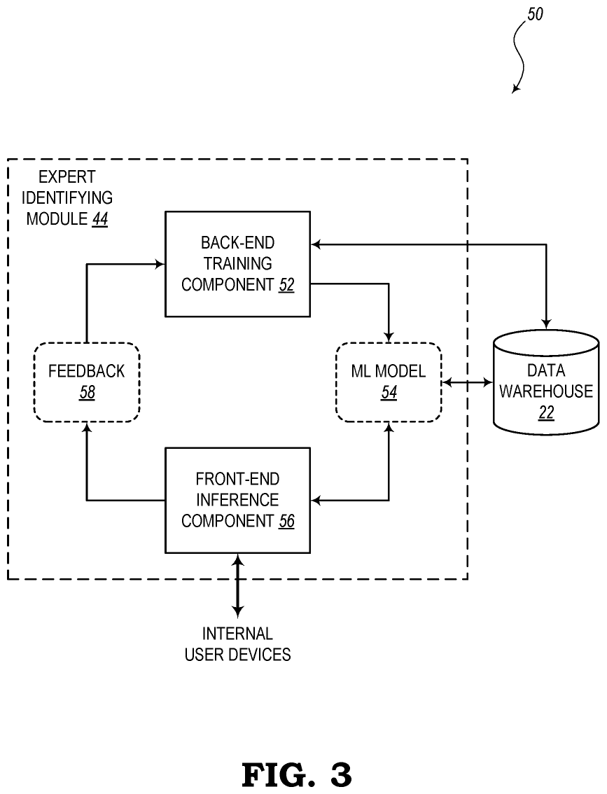

FIG. 3 is a block diagram illustrating an embodiment of a locating system 50 involving the data warehouse 22 and expert identifying module 44 shown in FIG. 2. As shown, the locating system 50 includes a back-end training component 52, which is configured to generate an ML model 54. The locating system 50 further includes a front-end inference component 56 that may serve users of one or more user devices internal to the organization 10. According to some embodiments, the front-end inference component 56 may also serve external users in a limited capacity, as described above. The front-end inference component 56 is configured to utilize the trained ML model 54, in conjunction with the data warehouse 22 (and table), to provide answers to enquiries about personnel and directory support issues. In response to the answers or results of the various enquiries, according to some embodiments, feedback 58 may be provided to the back-end training component 52 to further train or re-train the ML model 54 as needed.

Thus, the locating system 50 is configured to set up and use a database structure (e.g., the data warehouse 22) for storing information about the members of the organization 10, where the information may be indexed in a table. Also, the locating system 50 is configured to use AI functionality to not only train the ML model 54, but also to enable a user within the organization 10 to find a person or a group of people who can help with a particular topic or area of expertise.

The back-end training component 52 is configured to perform an initial crawling (data crawling) procedure, which may include going through the databases 14, 16, 18 to collect data. First, the initial crawling procedure may include adding the names of a plurality of members (or even all members) of the organization 10 into a table. Next, the initial crawling procedure may include a general assigning or attributing task, which may include generally attributing words (e.g., keywords) that are used throughout the records from the databases 14, 16, 18 to the members. For example, suppose an engineer uses the term or keyword “PQC” (or any variations of the term, such as “post-quantum cryptography,” “post quantum,” etc.) a certain number of times (e.g., 20 times). Suppose this term (and its variants) is found (by crawling or scraping processes) within internal documentation or records in a data silo 14, where the documentation is associated with the use of a specific software tool (e.g., Confluence, Slack, Jira, GitHub, etc.). In this case, the initial crawling procedure may include adding 20 to an “occurrence count” in a table column related to the term PQC next to the engineer's name. This initial stage may include rudimentary processing, which may include removing some words that have little or no significance or weight. The results of the initial crawling procedure may be stored in a table in the data warehouse 22.

After the initial crawling procedure, the back-end training component 52 may then perform a more in-depth training procedure, which may include deep learning techniques, machine learning techniques, AI-learning techniques, Large Language Model (LLM) techniques, etc. The in-depth procedure is configured to train the ML model 54 to cooperate with the data warehouse 22 (or other data storage device for maintaining names, keywords, occurrence counts, weights, proximity to the time of latest use of the keyword, etc.). The in-depth procedure may include another crawling process that involves going through the available data stored in the organization 10 and determining whether the keywords attributed or assigned to each person are used in a significant or meaningful way. The in-depth procedure may also include determining the commonality of keywords, where keywords that are only used by a small number of people may be considered to have more weight since they are more unique to those people. Also, if one person uses a certain keyword in a significant way more than others, then the in-depth technique may give more weight to the association of that keyword with that person. Other techniques and algorithms may be used to analyze the significance of certain words or phrases and how often each individual uses those words or phrases.

Then, if an inquiry, such as “Who should I talk to in order to find out about PQC?”, is received by the front-end inference component 56, then the individual who uses the term PQC (or similar terminology) in various databases more than others or in more significant ways may be interpreted as being the “expert” on this topic. Thus, the front-end inference component 56 can answer with this specific person. Also, if more than one person fits the criteria, the front-end inference component 56 may be configured to output multiple names with explanations of various details of the usage of the requested keyword. For example, the output answer may be presented as, “To learn more about PQC, you might want to talk to Gabriel S., who has used this term 50 times in the past 30 days. Or you might want to talk to Gary T. who has used this term in a presentation 3 hours ago.”

In some cases, the person identified as being the expert might not actually be the right person. For example, there may be situations where the expert person has recently left the organization 10 or they have been moved to a different department. Also, there may be some confusion about certain terminology that was not understood by the training modules, such as words that can have more than one meaning. Furthermore, some experts might be on sabbatical or on a long vacation and may be unavailable for a period of time. Another situation is that certain people may be hard to reach or difficult to talk with or unwilling to offer advice. Some of these uncalculated or unforeseen situations may be communicated to the back-end training component 52 via feedback 58. The feedback 58 may be from the user devices of the enquirers and/or information may be communicated to admin staff, HR staff, and/or IT staff, who can then communicate or enter various concerns or issues that can be used as feedback 58 that can be used by an operator of the expert identifying module 44 to change the algorithms and/or tables associated with the back-end training component 52 as needed to retrain the ML model 54.

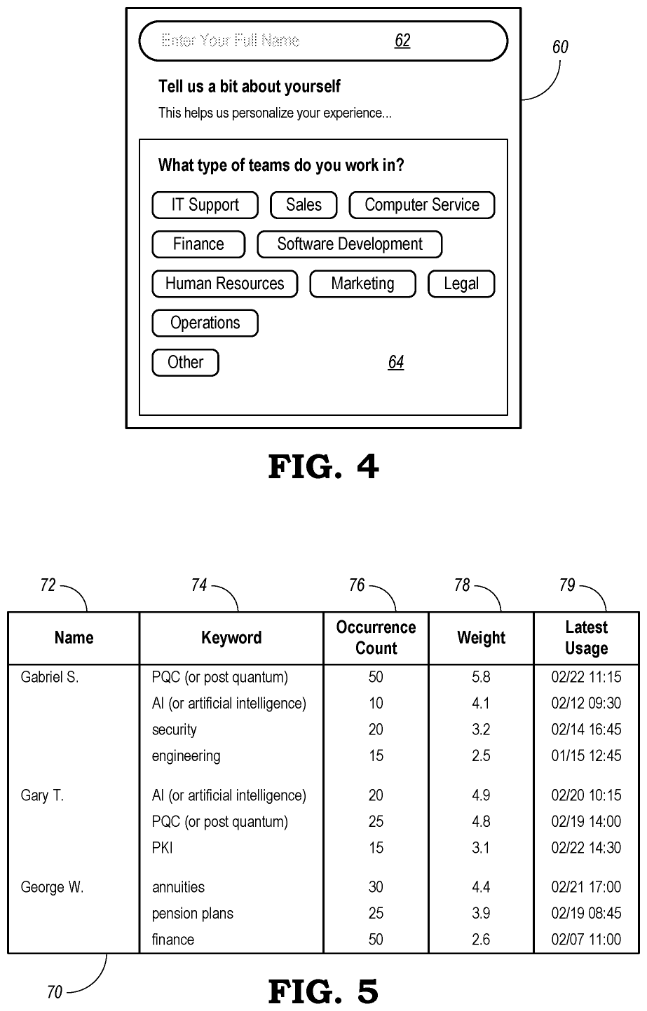

FIG. 4 is a diagram illustrating an embodiment of a user interface box 60 for gathering information about people within the organization 10. The user interface box 60 may be presented to new members (e.g., new employees in a company, new students in an educational environment, etc.). Also, the user interface box 60 may be presented to people who experience some change, such as being moved to a different department (e.g., internal group 12), being given more (or fewer) responsibilities, joining a new team, etc. As shown in this embodiments, the user interface box 60 may include a name field 62 allowing the user to enter their name. The user interface box 60 also includes a category box 64 having multiple buttons. The category box 64 allows a user to select one or more teams that they participate in. In the example shown in FIG. 4, the types of teams may include IT support, Sales, Computer Service, Finance, Software Development, Human Resources, Marketing, Legal, Operations, and Others. The information received in this manner may be entered into the HR database 16 and may be entered into a table (described below) for setting or adjusting the weights of various terms or keywords or for other purposes.

### Table of Names and Keywords

FIG. 5 shows an embodiment of a table 70 for storing names of people associated with an organization, keywords used by the people, number of occurrences of the keywords, weights of the keywords, and latest usage of the keywords. The table 70 may be stored in the data warehouse 22 and may be accessed as needed to determine one or more members who are deemed to be experts, have experience, are skilled, are knowledgeable about a specific topic, keyword, or phrase. The calculation of who is deemed to be an expert again may be based on various criteria, such as those shown in the table 70.

As illustrated, the table 70 includes a name column 72 that may include a plurality of members (or all members) of the organization 10. Also, the table 70 includes a keyword column 74 that includes words or phrases that have a certain level of significance and can be used to identify or distinguish one person from another. Next to each keyword is a count included in an occurrence count column 76, where the number of times that the respective person uses the keyword (or the number of times the keyword is otherwise attributed to or assigned to the person) is recorded. In some embodiments, the count may apply to the occurrences within a certain amount of time (e.g., within the past five years, within the past year, within the past three months, within the past month, etc.). The table 70 further includes a weight column 78, which includes a weight that is calculated for each keyword and person. The weight may be based on various factors, such as the rarity of words in normal human usage, differences in usages from other people in the organization 10, etc. Also, the table 70 includes a latest usage column 79 (which may be optional in some embodiments) that records the last time that the person used the keyword. The information of the latest usage may be used to add more significance to a person who has used the keyword most recently. These and other criteria may be calculated and recorded in the table 70 or other suitable data storage device and can be available to the ML model 54 for determining the expert or best person to answer questions about a certain topic, keyword, combination of keywords, etc.

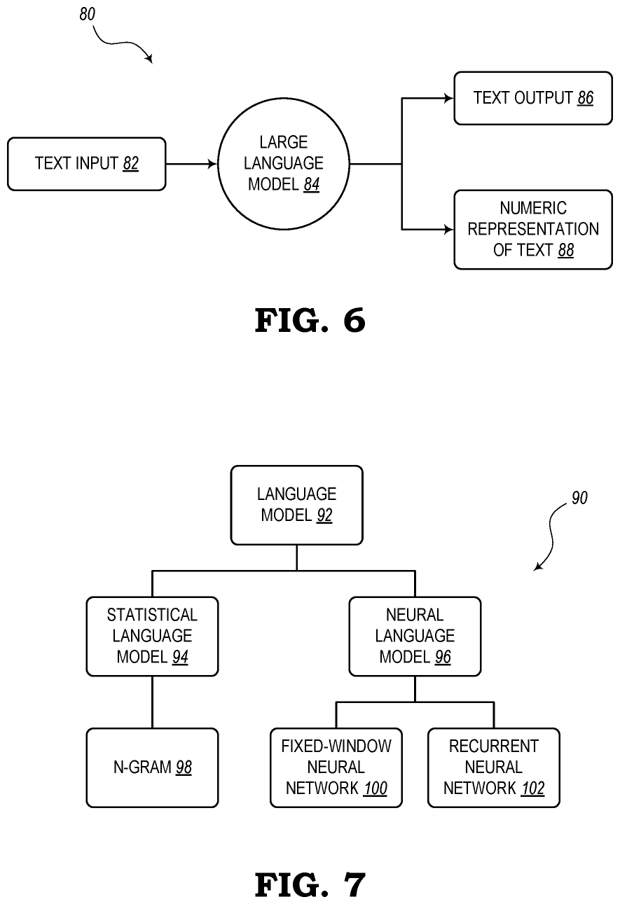

FIG. 6 is a block diagram illustrating an embodiment of a Large Language Model (LLM) based architecture 80. In this embodiment, the LLM-based architecture 80 includes text input 82 that receive text that is passed to a LLM 84. From the LLM 84, the LLM-based architecture 80 includes text output 86 and a numeric representation of text 88. For instance, the LLM-based architecture 80 may be configured for answering enquiries about the expertise of various individuals in the organization 10 and can provide answers related to the information stored in the table 70.

FIG. 7 is a block diagram illustrating an embodiment of a language-based architecture 90. The language-based architecture 90 in this embodiment includes a hierarchy where a language model 92 branches to a statistic language model 94 and a neural language model 96. The statistical language model 94 includes n-gram 98. The neural language model 96 branches to a fixed-window neural network 100 and a recurrent neural network 102.

### Method for Determining Expertise in an Organization

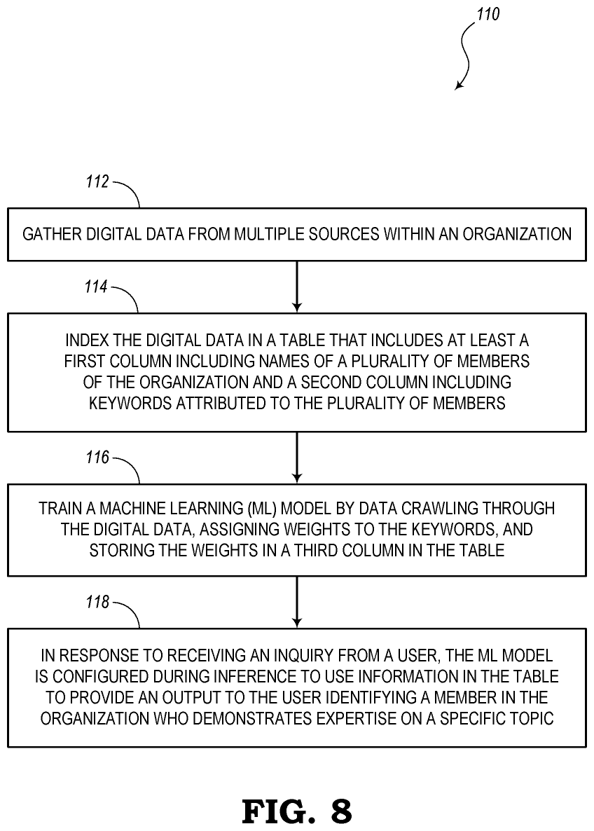

FIG. 8 is a flow diagram illustrating an embodiment of a method 110 for training a Machine Learning (ML) model for enabling a user to identify one or more people of an organization having expertise or knowledge in a specific topic or area of concern. As shown, the method 110 includes a step of gathering digital data from multiple sources within an organization, as indicated in block 112. The method 110 also include a step of indexing the digital data in a table that includes at least a first column including names of a plurality of members of the organization and a second column including keywords attributed to the plurality of members, as indicated in block 114. Also, the method 110 includes a step of training a Machine Learning (ML) model by data crawling through the digital data, assigning weights to the keywords, and storing the weights in a third column in the table, as indicated in block 116. In response to receiving an inquiry from a user, the ML model is configured during inference to use information in the table to provide an output to the user identifying a member in the organization who demonstrates expertise on a specific topic, as indicated in block 118.

According to additional embodiments, the step of training the ML model (block 116) may include a deep learning neural network process. The deep learning neural network process, for example, may involve a Large Language Model (LLM). The ML model, in some embodiments, may include a chatbot for receiving the inquiry and providing the output. The chatbot, for instance, may use Natural Language Processing (NLP). The inquiry described in block 118 may include the specific topic or one or more of the keywords.

The step of gathering the digital data (block 112) may include obtaining data from a plurality of databases. The databases, for example, may include at least a plurality of data silos each configured to store data in conjunction with use of one or more of collaboration tools, wiki tools, file sharing tools, messaging or chat tools, project management tools, and issue tracking tools associated with multiple different internal groups within the organization. In some embodiments, the user associated with the inquiry may be a fellow member of the organization (internal inquiry).

In some embodiments, the method 110 may be associated with systems, non-transitory computer-readable media, etc., which may include a back-end training component. The back-end training component may be configured to perform a rudimentary crawling or scraping process to store the digital data in the table and may further be configured to train the ML model. Also, a front-end inference component may be configured to a) receive the inquiry from a user device associated with the user, b) utilize the ML model and a data warehouse associated with the table to identify one or more members in the organization who demonstrate expertise on the specific topic, and c) provide the output to the user with an explanation describing how expertise is evaluated. The back-end training component may be configured to receive feedback for retraining the ML model.

Also, according to some implementations, the method 110 may further include the steps of counting a number of times each keyword is attributed to the plurality of members and storing an occurrence count in a fourth column in the table. The ML model, for example, may be configured to utilize the names, keywords, weights, occurrence counts, and/or proximity to time of use of the keywords to identify the member who demonstrates expertise in the specific topic.

### Additional Considerations

The systems and methods of the present disclosure are directed to training a ML model using information that may be stored in different isolated data storage devices throughout an organization. The systems and methods first collect the internal data in order to create an expertise persona, which can be used to direct enquiries about certain subjects to specific individuals who may be experts, have a significant level of experience, and/or are productive or prolific with respect to the subject in question.

In particular, it may be easy in a small organization to ask the handful of employees about a certain matter. However, there may be a problem when the organization grows to dozens, hundreds, even thousands of employees. There may be certain individuals or groups of individuals who hold a vast among of knowledge about certain areas of expertise or experience. For example, this could be architectural design, finance, marketing, engineering, etc. In a large organization, someone unfamiliar with a certain department or topic (e.g., a newcomer to the organization) may have difficulty searching through directories to find the right person who may be able to answer questions. It can be challenging to get the knowledge from those individuals or locate the right person for talking face-to-face.

Before identifying and establishing a connection to individuals who may be experts in various fields, the systems and methods of the present disclosure are configured to retrieve internal data from every corner of the organization and train a ML or AI model based on all the content that might be available through various sources, such Confluence, Slack messages, GitHub repositories, or other internal tools and databases. Training the ML model may include creating personas that identify individuals as the face of organization with respect to certain areas of technology or expertise.

The source of data may include the databases shown in FIG. 1 and other sources, such as emails, meeting notes, files stored on various computers, etc. Next, the systems and methods start relating, associating, or attributing specific meaningful keywords to different people, based on whoever entered or recorded the words in any form throughout the organization, to form the associated expertise personas.

Returning to the example of FIG. 5, Gabriel S. is credited with using the term PQC (and related terminology) 50 times and using the term AI (and related terminology) 10 times. Also, it may be determined, for example, that Gabriel S. has used PQC and AI in recent days. The front-end inference component 56 (e.g., chatbot) and/or ML model 54 may be configured to analyze an inquiry, for example, about “Who is the right person to talk to about PQC and AI?” The ML model 54 may determine that Gabriel S. has the highest occurrences of PQC+AI (i.e., 50+10=60). However, the ML model 54 may also account for the fact that Gary T. using AI 20 times and PQC 25, which, although it is a smaller total compared to Gabriel S., there is a more equal distributed of occurrences of PQC and AI (i.e., at least 20 each), whereas AI is only attributed to Gabriel S. 10 times. Other algorithms and techniques may be used to decrypt enquiries and provide useful answers, even providing multiple answers, such as “To learn about PQC and AI, both Gabriel S. and Gary T. have written about these things many times over the past month. With respect to PQC, it seems like Gabriel S. probably has more knowledge and wrote about PQC three hours ago. Click on the following link to access this document. On the other hand, Gary T. probably has more knowledge with respect to AI. Gary T.'s last available submission, conversation, or public knowledge according to the in-company's internal system regarding the subject of AI was 2 days ago.”

Furthermore, according to different types of organizations, other examples can be given. For example, in a financial services company or a financial branch or group within an organization, an inquirer may ask, “Hey, Internal AI Directory Support. Who knows a lot about annuities and pension plans?” In the United States Patent and Trademark Office (USPTO), an inquirer may ask, “What's the person's name who works in Class 324 and issued a bunch of patents related to testing piezoelectric devices?”

In addition, the two stages of operation of the back-end training component 52 may be configured to include a first stage where a table (e.g., table 70) is created in a general, rudimentary way and provides a skeleton. The next stage includes using ML to go through the data again, tweak the weights, find intelligence in the usage of various words, find phrases used in meaningful ways, etc. to figuratively put meat on the bones. The name column 72 may be considered to be a “key.” The keyword column 74 may be considered to be a “value.” Also, the weight column 78 may be considered to be a “value weight.” The information is entered in the table 70 and changed according to various criteria for establishing and modifying the persona for each member.

### CONCLUSION

It will be appreciated that some embodiments described herein may include one or more generic or specialized processors (“one or more processors”) such as microprocessors; central processing units (CPUs); digital signal processors (DSPs): customized processors such as network processors (NPs) or network processing units (NPUs), graphics processing units (GPUs), or the like; field programmable gate arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more application-specific integrated circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a read-only memory (ROM), a programmable read-only memory (PROM), an erasable programmable read-only memory (EPROM), an electrically erasable programmable read-only memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A non-transitory computer-readable medium for storing computer logic having instructions that enable a processing device to perform steps of:
gathering digital data from multiple sources within an organization;
indexing the digital data in a table that includes at least a first column including names of a plurality of members of the organization and a second column including keywords attributed to the plurality of members; and
training a Machine Learning (ML) model by data crawling through the digital data, assigning weights to the keywords, and storing the weights in a third column in the table;
wherein, in response to receiving an inquiry from a user, the ML model is configured during inference to use information in the table to provide an output to the user identifying a member in the organization who demonstrates expertise on a specific topic.

2. The non-transitory computer-readable medium of claim 1, wherein training the ML model includes a deep learning neural network process.

3. The non-transitory computer-readable medium of claim 2, wherein the deep learning neural network process involves a Large Language Model (LLM).

4. The non-transitory computer-readable medium of claim 1, wherein the ML model includes a chatbot for receiving the inquiry and providing the output, and wherein the chatbot uses Natural Language Processing (NLP).

5. The non-transitory computer-readable medium of claim 1, wherein the inquiry includes the specific topic or one or more of the keywords.

6. The non-transitory computer-readable medium of claim 1, wherein gathering the digital data includes obtaining data from a plurality of databases.

7. The non-transitory computer-readable medium of claim 6, wherein the databases include at least a plurality of data silos each configured to store data in conjunction with use of one or more of collaboration tools, wiki tools, file sharing tools, messaging or chat tools, project management tools, and issue tracking tools associated with multiple different internal groups within the organization.

8. The non-transitory computer-readable medium of claim 1, wherein the user associated with the inquiry is a fellow member of the organization.

9. The non-transitory computer-readable medium of claim 1, wherein a back-end training component is configured to perform a rudimentary crawling or scraping process to store the digital data in the table, the back-end training component further configured to train the ML model.

10. The non-transitory computer-readable medium of claim 9, wherein a front-end inference component is configured to:
receive the inquiry from a user device associated with the user;
utilize the ML model and a data warehouse associated with the table to identify one or more members in the organization who demonstrate expertise on the specific topic; and
provide the output to the user with an explanation describing how expertise is evaluated.

11. The non-transitory computer-readable medium of claim 9, wherein the back-end training component is configured to receive feedback for retraining the ML model.

12. The non-transitory computer-readable medium of claim 1, wherein the instructions further enable the processing device to perform steps of counting a number of times each keyword is attributed to the plurality of members and storing an occurrence count in a fourth column in the table.

13. The non-transitory computer-readable medium of claim 12, wherein the ML model is configured to utilize the names, keywords, weights, occurrence counts, and/or proximity to time of use of the keywords to identify the member who demonstrates expertise in the specific topic.

14. A system comprising:
a processing device; and
memory configured to store computing code having instructions that enable the processing device to perform steps of
gathering digital data from multiple sources within an organization;
indexing the digital data in a table that includes at least a first column including names of a plurality of members of the organization and a second column including keywords attributed to the plurality of members; and
training a Machine Learning (ML) model by data crawling through the digital data, assigning weights to the keywords, and storing the weights in a third column in the table;
wherein, in response to receiving an inquiry from a user, the ML model is configured during inference to use information in the table to provide an output to the user identifying a member in the organization who demonstrates expertise on a specific topic.

15. The system of claim 14, wherein training the ML model includes a Large Language Model (LLM).

16. The system of claim 14, wherein the ML model includes a chatbot for receiving the inquiry and providing the output, and wherein the chatbot uses Natural Language Processing (NLP).

17. The system of claim 14, wherein gathering the digital data includes obtaining data from a plurality of databases including one or more data silos each configured to store data in conjunction with use of one or more of collaboration tools, wiki tools, file sharing tools, messaging or chat tools, project management tools, and issue tracking tools associated with multiple different internal groups within the organization.

18. A method comprising steps of:
gathering digital data from multiple sources within an organization;
indexing the digital data in a table that includes at least a first column including names of a plurality of members of the organization and a second column including keywords attributed to the plurality of members; and
training a Machine Learning (ML) model by data crawling through the digital data, assigning weights to the keywords, and storing the weights in a third column in the table;
wherein, in response to receiving an inquiry from a user, the ML model is configured during inference to use information in the table to provide an output to the user identifying a member in the organization who demonstrates expertise on a specific topic.

19. The method of claim 18, further comprising steps of:
receiving the inquiry from a user device associated with the user;
utilizing the ML model and a data warehouse associated with the table to identify one or more members in the organization who demonstrate expertise on the specific topic; and
providing the output to the user with an explanation describing how expertise is evaluated.

20. The method of claim 18, further comprising steps of:
counting a number of times each keyword is attributed to the plurality of members and storing an occurrence count in a fourth column in the table; and
applying the ML model by utilizing the names, keywords, weights, occurrence counts, and/or proximity to time of use of the keywords to identify the member who demonstrates expertise in the specific topic.
